(19) United States
(12) Patent Application Publication
(10) Pub. No.: US 2016/0001757 A1
(43) Pub. Date: Jan. 7, 2016

(54) VEHICLE BRAKING SYSTEM

(71) Applicant: COMMISSARIAT A L'ENERGIE ATOMIQUE ET AUX ENERGIES ALTERNATIVES, Paris (FR)

(72) Inventors: Fabien GRANGETTE, Grenoble (FR); Daniel CHATROUX, Teche (FR); Matthieu DESBOIS-RNAUDIN, Villard De Lans (FR)

(73) Assignee: Commissariat A L'Energie Atomique Et Aux Energies Alternatives, Paris (FR)

(21) Appl. No.: 14/769,576

(22) PCT Filed: Feb. 25, 2014
(86) PCT No.: PCT/FR2014/050393

§ 371 Date: Aug. 21, 2015

(30) Foreign Application Priority Data
Feb. 25, 2013 (FR) 1351625

(51) Int. Cl. B60T 13/74; B60T 13/66; B60T 13/58

(52) U.S. Cl. CPC B60T 13/745; B60T 13/588; B60T 13/662

(57) ABSTRACT

The instant disclosure describes a braking system for braking at least a first wheel of a motor vehicle comprising a first brake, a hydraulic circuit for controlling the first brake and a first electric motor for controlling the first brake, which brake and motor can be actuated at least partially simultaneously using one and the same actuating member.

### BACKGROUND

The present description relates to a braking system of a vehicle, particularly an automobile vehicle, comprising a brake-assist device.

### DISCUSSION OF THE RELATED ART

In most conventional vehicles, the vehicle wheel braking system comprises, for each wheel, a drum or disk brake controlled by a hydraulic circuit. On older vehicles, the hydraulic circuit comprises a master cylinder directly controlled by the brake pedal. The braking force applied by each brake is then directly linked to the force exerted by the driver on the brake pedal.

On more recent vehicles, a brake-assist device is provided between the brake pedal and the master cylinder to amplify the force exerted by the driver on the brake pedal. The brake-assist device may use a source of additional energy, for example, pneumatic, which adds to the energy provided by the driver when pressing on the brake pedal. As an example, the brake-assist device may comprise a vacuum booster, for example, of Mastervac type, which requires a depression source for its operation. The pneumatic power source may correspond to the depression in the inlet line of a gasoline motor or to the depression provided by a vacuum pump, for example, for a vehicle comprising a diesel-type motor or for an electric vehicle.

### SUMMARY

Thus, an embodiment provides a braking system for at least one first wheel of a motor vehicle comprising a first brake, a hydraulic circuit for controlling the first brake and a first electric motor for controlling the first brake which can be at least partly simultaneously actuated by a same actuation member.

According to an embodiment, the system comprises a sensor capable of providing a signal representative of the driver's action on the actuation member, a processing unit capable of providing a set point value from said signal, the first electric motor being controlled based on said set point value.

According to an embodiment, the first brake is hydraulically controlled and mechanically controlled, the hydraulic circuit being connected to the hydraulic control system of the first brake and the first electric motor being connected to the mechanical control system of the first brake.

According to an embodiment, the hydraulic circuit comprises a master cylinder connected to the hydraulic control system of the first brake by at least one pipe containing a brake fluid, the braking system comprising a connection mechanism connecting the actuation member to at least one piston of the master cylinder, the connection mechanism comprising no servo-brake.

According to an embodiment, the system comprises a second hydraulically controlled and mechanically controlled brake, the hydraulic circuit being connected to the hydraulic control system of the second brake.

According to an embodiment, the first motor is further connected to the mechanical control system of the second brake.

According to an embodiment, the system further comprises a second electric motor connected to the mechanical control system of the second brake and controlled by the actuation member at least partly simultaneously with the hydraulic circuit.

According to an embodiment, the system comprises a third hydraulically controlled and mechanically controlled brake, the hydraulic circuit being connected to the hydraulic control system of the third brake.

According to an embodiment, the first motor is further connected to the hydraulic control system of the third brake.

According to an embodiment, the system further comprises a third electric motor connected to the mechanical control system of the third brake and controlled by the actuation member at least partly simultaneously with the hydraulic circuit.

According to an embodiment, the system comprises a fourth hydraulically controlled and mechanically controlled brake, the hydraulic circuit being connected to the hydraulic control system of the fourth brake.

According to an embodiment, the first motor is further connected to the hydraulic control system of the fourth brake.

According to an embodiment, the system further comprises a fourth electric motor connected to the mechanical control system of the fourth brake and controlled by the actuation member at least partly simultaneously with the hydraulic circuit.

An embodiment also provides a vehicle comprising at least one wheel and a system for braking said wheel as previously defined.

### BRIEF DESCRIPTION OF THE DRAWINGS

The foregoing and other features and advantages will be discussed in detail in the following non-limiting description of specific embodiments in connection with the accompanying drawings, among which:

FIG. 1 schematically shows a conventional example of a braking system;

FIG. 2 schematically illustrates an embodiment of a braking system;

FIG. 3 schematically shows an example of a disk brake;

FIG. 4 schematically shows an example of a drum brake; and

FIGS. 5 to 8 show embodiments of braking systems.

### DETAILED DESCRIPTION

For clarity, the same elements have been designated with the same reference numerals in the various drawings and, further, the various drawings are not to scale. Further, only those elements which are useful to the understanding of the present description have been shown and will be described. In particular, the structure of the master cylinder of the hydraulic circuit of a braking system has not been described in detail. In the following description, unless otherwise indicated, terms “substantially”, “approximately”, and “in the order of” mean “to within 10%”.

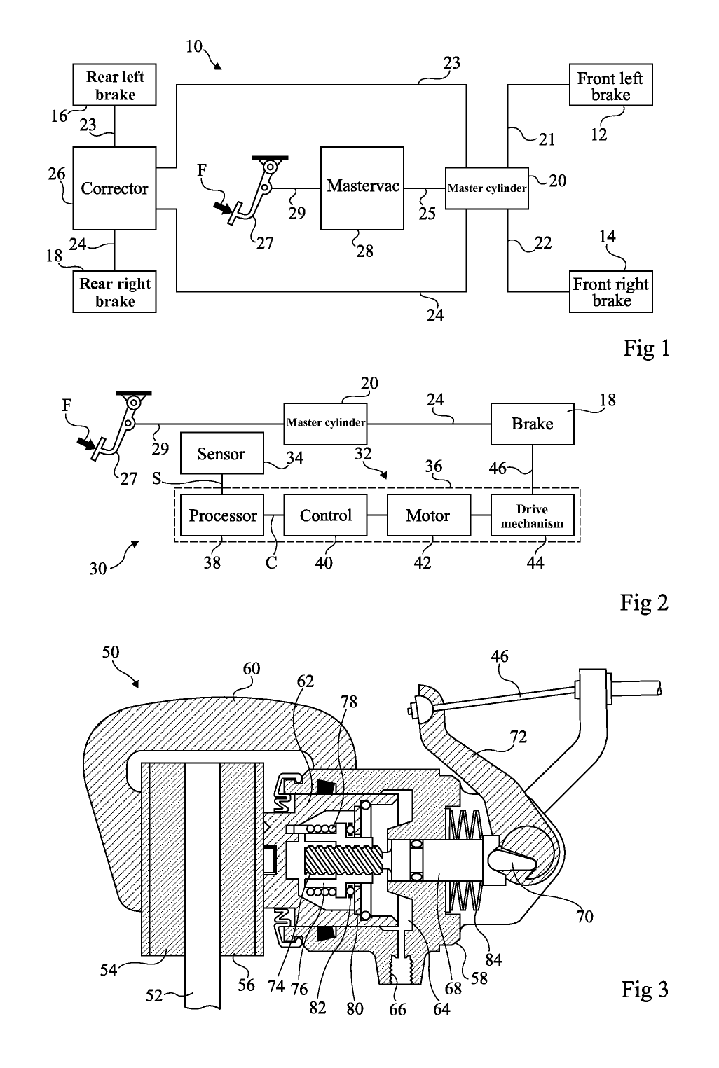

FIG. 1 shows an example of braking system 10. System 10 comprises a front left brake 12, a front right brake 14, a rear left brake 16, and a rear right brake 18 fitting the two front wheels and the two back wheels of the vehicle. Brakes 12, 14, 16, and 18 may be disk or drum brakes. Brakes 12, 14, 16, and 18 are controlled by a hydraulic circuit containing a brake fluid.

The hydraulic circuit comprises a master cylinder 20 connected to front left brake 12 by a pipe 21, to front right brake 14 by a pipe 22, to rear left brake 16 by a pipe 23, and to rear right brake 18 by a pipe 24. Master cylinder 20 comprises one or a plurality of pistons, not shown, capable of being displaced by a rod 25. A displacement of rod 25 results in a displacement of the pistons in master cylinder 20, which causes a variation of the hydraulic pressure in brakes 12 to 18. A pressure regulation device 26, or hydraulic corrector, may be provided on ducts 23 and 24 so that the hydraulic pressure in rear brakes 16, 18 is lower than the hydraulic pressure in front brakes 12, 14.

Master cylinder 20 is actuated by brake pedal 27 of the vehicle via a brake-assist device 28. The driver's action on brake pedal 27 causes the displacement of a push rod 29 which controls brake-assist device 28. Brake-assist device 28 applies an effort to rod 25, which corresponds to the effort exerted by the driver on brake pedal 27 multiplied by an amplification factor.

When the driver presses on brake pedal 27, which is illustrated by arrow F, rod 25 is displaced by brake-assist device 28. This causes a displacement of the pistons in master cylinder 20 and causes a pressure rise of the brake fluid in pipes 21, 22, 23, and 24, thus actuating brakes 12, 14, 16, and 18.

A disadvantage of previously-described braking system 10 is that brake-assist device 28 and pressure regulation device 26 occupy a significant volume. Further, the costs of manufacturing and maintenance of brake-assist device 28 and of pressure regulation device 26 are generally high. Further, the operation of assistance device 28 may require the presence of a vacuum pump, which may also be bulky and expensive.

An object of an embodiment is to decrease the volume and the number of parts of the hydraulic control circuit of the brakes of a braking system.

Another object of an embodiment is to suppress the hydraulic and/or pneumatic brake-assist device between the brake pedal and the master cylinder.

FIG. 2 illustrates the operating principle of an embodiment of a braking system 30. In FIG. 2, for simplification, only brake 18 is shown.

According to this embodiment, push rod 29 driven by brake pedal 27 is directly connected to the pistons of master cylinder 20. There thus is no hydraulic and/or pneumatic brake-assist device interposed between push rod 29 and master cylinder 20.

Braking system 30 further comprises a brake-assist device 32. Device 32 comprises a sensor 34 and an electromagnetic brake-assist system 36 connected to sensor 34 and to brake 18.

Sensor 34 provides a signal S which is representative of the driver's action on pedal 27. Sensor 34 may be a sensor measuring the displacement of push rod 29 or the angular displacement of brake pedal 27, a sensor measuring the force exerted by the driver on brake pedal 27 or the force exerted by brake pedal 27 on push rod 29 or a sensor of the hydraulic pressure in master cylinder 20.

System 36 comprises:
a processing unit 38 receiving signal S;
a control unit 40;
an electric motor 42 controlled by control unit 40;
a drive mechanism 44 driven by motor 42; and
a mechanical connection element 46, for example, a cable, connecting drive mechanism 44 to brake 18.

Brake 18 may be controlled in two ways: by a hydraulic control or by a mechanical control. This is true for most current brakes, particularly disk or drum brakes, which generally comprise, in addition to the hydraulic control, a cable control conventionally used to achieve a parking brake function. In this case, connection element 46 of assistance device 32 is connected to the cable control system of brake 18.

Processing unit 38 for example comprises a microcontroller. Processing unit 38 may further comprise a memory having a sequence of instructions which control the operation of processing unit 38 stored therein. As a variation, processing unit 38 may be formed by a dedicated electronic circuit. Processing unit 38 is capable of providing a set point value C to control unit 40 of electric motor 42, particularly according to signal S. As an example, set point value C is all the higher as the action exerted by the driver on brake pedal 27 is significant.

Control unit 40 for example comprises a circuit capable of controlling the torque and/or the rotation speed of electric motor 42 according to set point value C, for example, by adapting the power supply current and/or voltage of motor 42.

Electric motor 42 may be powered with an electric power source, for example, obtained from the voltage delivered by the vehicle battery. Electric motor 42 for example is a rotating motor, particularly a DC current rotating motor. Electric motor 42 is capable of exerting, via drive mechanism 44, a traction on cable 46 for pulling brake 18 having an intensity depending on set point value C.

Drive mechanism 44 is located between electric motor 42 and cable 46. It has the function of transforming the rotating motion of electric motor 42 into a motion of translation of cable 46. It may be a rack drive mechanism or a screw/nut type drive mechanism. Preferably, it is a reversible drive mechanism to enable cable 46 to return to its released position when electric motor 42 is not powered. Cable 46 is connected at one end to a lever located in brake 18, as described in further detail hereafter, and is connected, at the opposite end, to drive mechanism 44.

Assistance device 32 is capable of controlling a braking action of brake 18 simultaneously to the braking action controlled by master cylinder 20.

According to an embodiment, assistance device 32 further comprises a force sensor, not shown in FIG. 2, capable of providing processing unit 38 with a signal representative of the intensity of the fraction exerted on cable 46. Processing unit 38 then implements a feedback loop to adapt the value of set point value C according to the intensity of the traction really exerted on the cable.

FIG. 3 shows an embodiment of a disk brake 50 capable of corresponding to brake 18 of FIG. 2. Brake 50 comprises at least one disk 52 rotated by the vehicle wheel, not shown, and located between two friction pads 54, 56. Brake 50 comprises a cylinder 58 connected to friction pad 54 by a caliper 60. A piston 62 is assembled to freely slide in cylinder 58. Piston 62 defines with cylinder 58 a chamber 64 filled with the brake fluid and which communicates with pipe 24, not shown in FIG. 3, through an opening 66. Brake 50 further comprises a axis 68 slidably assembled on cylinder 58 and capable of being displaced in translation with respect to cylinder 58 via a tappet 70 actuated by a lever 72. Lever 72 may be pivoted via cable 46. The end of axis 68 comprises a threaded portion 74. A nut 76 is arranged on threaded portion 74. A torsion spring 78 bears against piston 62 at one end and against nut 76 at the opposite end. Brake 50 further comprises a washer 80, fixed with respect to piston 62, and a ball thrust bearing 82, between nut 76 and washer 80. Resilient return means 84, for example, comprising Belleville spring washers, connects one end of axis 68 to cylinder 58. The system comprising nut 76, spring 78, washer 80, and bearing 82 is a system for compensating for the pad wearing.

The hydraulic control of brake 50 operates as follows. Under the action of the pressure of the brake fluid penetrating in chamber 64, piston 62 displaces in cylinder 58 and pushes pad 56 against disk 52. By reaction, caliper 60 displaces in turn to come into contact with second pad 54 on the other surface of disk 52. During the stroke of piston 62, washer 80 may stop against ball thrust bearing 82. If the stroke of piston 62 is significant, nut 76 may be driven by ball thrust bearing 82 and washer 80. The displacement of nut 76 causes a rotation thereof around threaded portion 74 which has its rotation stopped by tappet 70 and lever 72. The rotation of nut 76 is eased by spring 78 fastened to piston 62 and stressed in its spiral unwinding direction. At the brake release, spring 78 is stressed in its spiral winding direction and blocks the rotation of nut 76.

The mechanical control of brake 50 operates as follows. A traction on cable 46 causes a pivoting of lever 72. Under the action of lever 72 and of tappet 70, axis 68 displaces with respect to cylinder 58 until nut 76 comes into contact with piston 62. Axis 68 then causes the sliding of piston 62 inside of cylinder 58. This puts pad 56 into contact with disk 52. When the traction on cable 46 stops, lever 72 resumes its initial position under the return effort of washers 84. Screw/nut system 74, 76 enables to take into account the wearing of pads 54, 56. Indeed, according to the wearing of the system, spring 78 more or less strongly unscrews nut 76, which enables to increase the stroke length to catch up on the pad wearing.

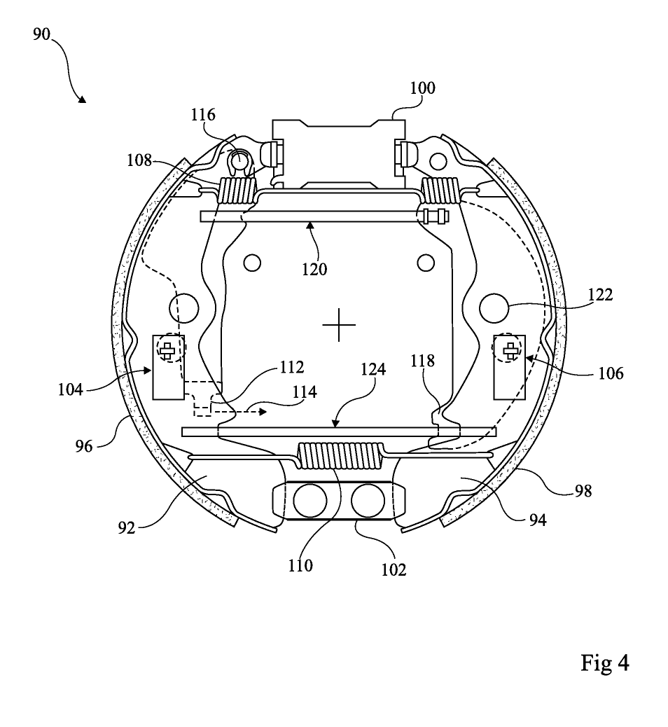

FIG. 4 shows an embodiment of a drum brake 90 capable of corresponding to brake 18 of FIG. 2. Brake 90 is mounted on a support, not shown, fixed with respect to the vehicle frame. Brake 90 comprises two brake shoes 92, 94, each brake shoe 92, 94 being provided with a friction lining 96, 98. Brake 90 comprises a slave cylinder 100, attached to the support and connected to an upper end of each brake shoe 92, 94. Cylinder 100 is further connected to the hydraulic circuit of the braking system. The lower ends of brake shoes 92, 94 may stop against a guide 102 attached to the support. Brake shoes 92, 94 are connected to the support via anchor springs 104, 106 allowing a displacement of limited amplitude of brake shoes 92, 94 with respect to the support. The upper ends of brake shoes 92, 94 are connected to each other by a spring 108 and the lower ends of brake shoes 92, 94 are connected to each other by a spring 110.

Brake 90 further comprises a lever 112 on which cable 46 is capable of exerting a force along arrow 114. Lever 112 is pivotally assembled with respect to brake shoe 92 at the level of a pin joint 116. Lever 112 is connected to an additional lever 118 via an adjustment mechanism 120 which enables to compensate for the wearing of friction linings 96, 98. Additional level 118 is assembly to freely rotate with respect to brake shoe 94 around a pin joint 122. Additional lever 118 is connected to brake shoe 92 by a connecting rod 124.

The hydraulic control of brake 90 operates as follows. When a brake fluid overpressure penetrates into cylinder 100, this causes a displacement of the pistons of cylinder 100, which spaces apart the upper ends of brake shoes 92, 94. Friction linings 96, 98 come into contact with the drum, not shown, of the vehicle wheel to perform the braking operation. When the brake fluid pressure drops, the shoes are taken back to their position of rest by return springs 108, 110.

The mechanical control of brake 90 operates as follows. A traction on cable 46 causes a pivoting of braking lever 112 around pin joint 116. This causes, via adjustment mechanism 120, a pivoting of secondary lever 118 and a displacement of connecting rod 114, whereby brake shoes 92, 94 are spaced apart until friction linings 96, 98 come into contact with the wheel drum. When the traction on cable 46 stops, the shoes are taken back to their position of rest by return springs 108, 110.

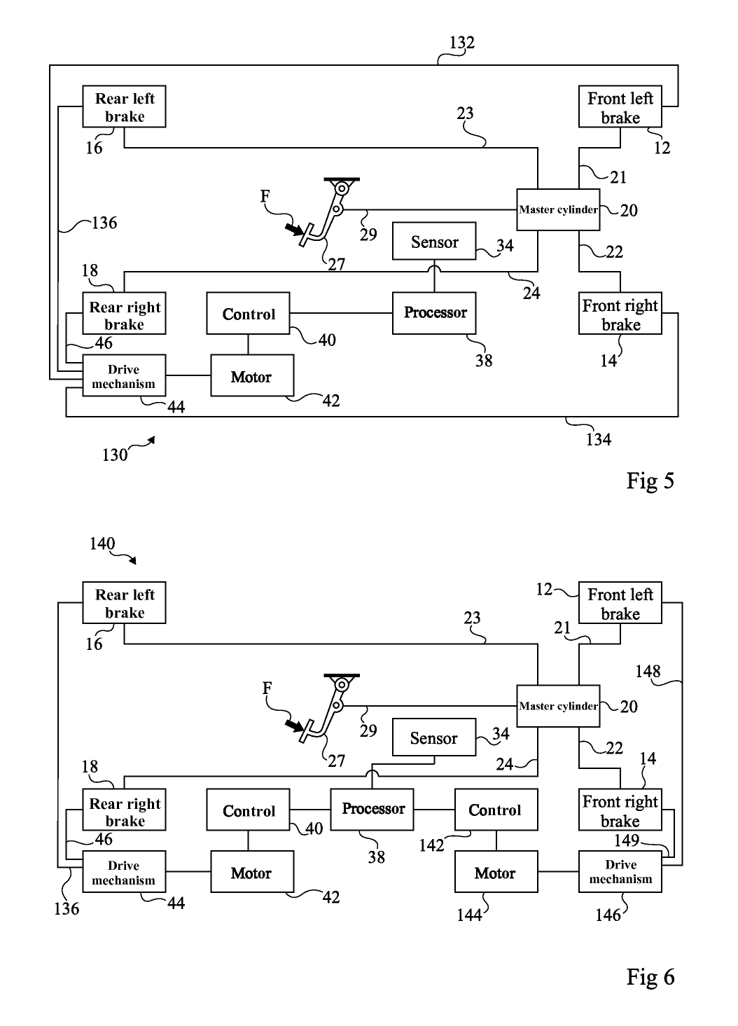

FIG. 5 shows an embodiment of a braking system 130 where the assistance device comprises a single electric motor for all four brakes 12, 14, 16, and 18 of the vehicle. In this case, in addition to being connected to brake 18 by cable 46, drive mechanism 44 is connected to brake 12 by a cable 132, to brake 14 by a cable 134, and to brake 16 by a cable 136.

FIG. 6 shows an embodiment of a braking system 140 where, as compared with braking system 130 shown in FIG. 5, drive mechanism 44 is only connected to rear left brake 16 and to rear right brake 18. The assistance device further comprises a control unit 142 connected to processing unit 38, a motor 144 controlled by control unit 142, and a drive mechanism 146 connected to motor 144. Control unit 142, motor 144, and drive mechanism 146 are similar, respectively, to control unit 40, to motor 42, and to drive mechanism 44. Drive mechanism 146 is for example connected to front left brake 12 by a cable 148 and to front right brake 14 by a cable 149.

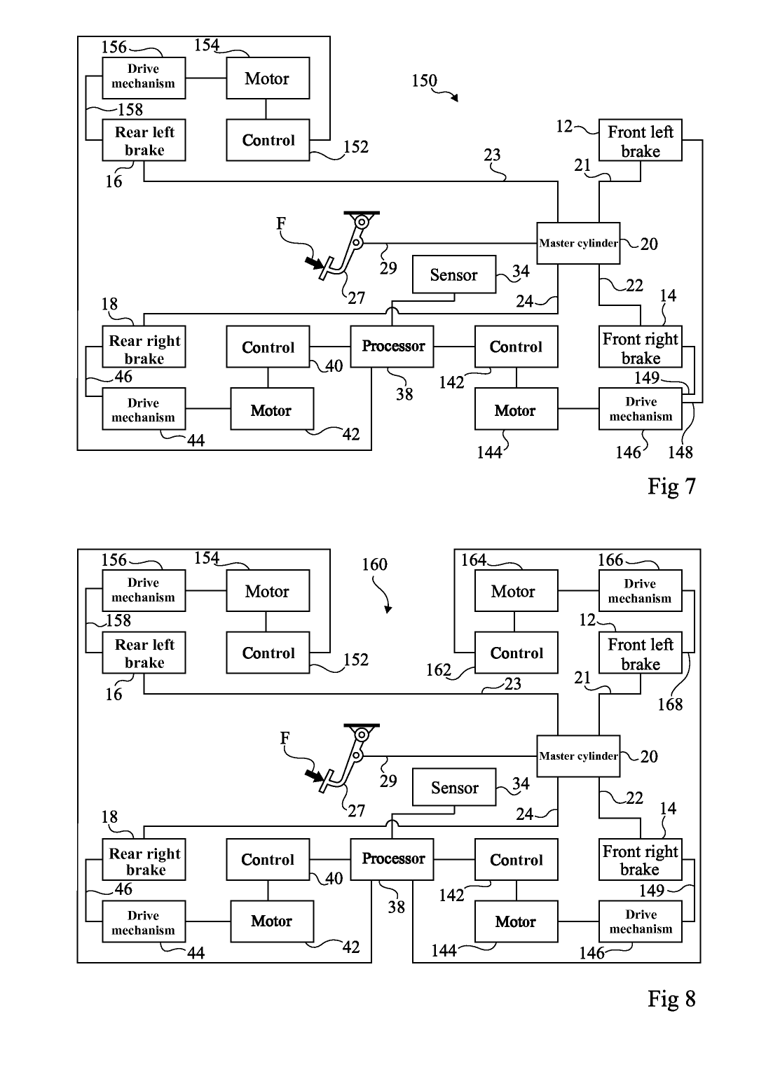

FIG. 7 shows another embodiment of a braking system 150 where, as compared with braking system 140 shown in FIG. 6, drive mechanism 44 is only connected to rear right brake 18. The brake-assist device further comprises a control unit 152 connected to processing unit 38, a motor 154 controlled by control unit 152, and a drive mechanism 156 connected to motor 154. Control unit 152, motor 154, and drive mechanism 156 are similar, respectively, to control unit 40, to motor 42, and to drive mechanism 44. As an example, drive mechanism 156 is only connected to rear left brake 16 by a cable 158.

FIG. 8 shows another embodiment of a braking system 160 where, as compared with braking system 150 shown in FIG. 7, drive mechanism 146 is only connected to front right brake 14. The assistance device further comprises a control unit 162 connected to processing unit 38, a motor 164 controlled by control unit 162, and a drive mechanism 166 connected to motor 164. Control unit 162, motor 164, and drive mechanism 166 are similar, respectively, to control unit 40, to motor 42, and to drive mechanism 44. As an example, drive mechanism 166 is only connected to front left brake 12 by a cable 168.

The previously-described embodiments of braking systems 30, 130, 140, 150, 160 enable to carry out a brake-assist function. Advantageously, they may be implemented with conventional brakes comprising a hydraulic control, conventionally used for braking operations when the vehicle is moving, and a mechanical control, for example, by cable, conventionally used to carry out a parking brake function. However, according to the present embodiments of the braking system, the mechanical control is further used to carry out the brake-assist function when the vehicle is moving, that is, jointly with the hydraulic control.

Braking system 30, 130, 140, 150, 160 may further be used to carry out a parking brake function. The mechanical control of the brakes may be actuated by a button, for example placed on the central console behind the gear lever. This advantageously enables to free the location usually provided for the hand brake lever. The parking brake function is obtained by actuating the electric motor or the electric motors on the brakes of the rear and/or front axles. As an example, as soon as the driver presses on the parking brake button, the electric motor or the electric motors exert a traction on the cables, which actuates the brakes.

According to an embodiment, the vehicle may further comprise an inclination sensor which is used to detect the pavement inclination. To achieve the parking brake function, the traction force to be exerted on the cables can then be determined by processing unit 38 according to this inclination. As an example, the pulling is all the stronger as the inclination is strong. To achieve the parking brake function, the brake-assist device further comprises locks capable of preventing the return to the released position of the cables when the electric motor(s) are not longer supplied with current. The lock can then be unlocked when the driver deactivates the parking brake.

Braking system 30, 130, 140, 150, 160 may further be used to carry out a hill start assistance function. Such a function enables to avoid for the car to move backwards or to stall during a hill starting. To carry out this function, the vehicle further comprises one sensor or more, capable of indicating to processing unit 38 that the driver intends to start. As an example, the vehicle comprises a sensor housed on the clutch pedal, capable of providing processing unit 38 with a signal representative of the fact that the driver presses on the clutch pedal and/or another sensor housed in the gear box, capable of providing processing unit 38 with a signal representative of the fact that the driver sets a speed ratio. Further, processing unit 38 may receive a signal representative of the drive torque applied to the wheels. According to all these data, processing unit 38 may control the application of a force adapted to the brake control cables.

Braking system 30, 130, 140, 150, 160 may further be used to carry out a motor brake function. As an example, the motor brake function by the braking system may be achieved when the vehicle battery is fully charged so that the driver has the same driving sensation independently from the battery state of charge. Indeed, when the battery is being charged, the driver feels a braking which is due to the portion of the energy supplied by the vehicle wheel drive motor, used to drive the alternator recharging the battery while this braking is absent when the battery is fully charged.

For this purpose, processing unit 38 may adapt the application force of brakes 12, 14, 16, 18 according to the braking force due to the battery charge. When the driver lifts his/her foot off the accelerator pedal and the battery is fully charged, the brake-assist device may provide a braking force to replace the braking force which would be present if the battery was charging. In the embodiments previously described in FIGS. 6, 7, and 8, the braking effort may be provided on the front wheels only. This advantageously enables the driver to have exactly the same driving sensation, for a front-wheel drive vehicle, as when the motor brake is present.

Braking system 30, 130, 140, 150, 160 may further play the role of an anti-lock braking system ABS. Processing unit 38 is then capable of controlling the decrease, or even the stopping, of the braking action exerted by the brake on the corresponding wheel in the case where this wheel is about to be totally blocked by the brake.

On a conventional hydraulic braking system such as shown in FIG. 1, the anti-lock function is obtained by additional hydraulic groups enabling to regulate the pressure in the slave cylinders of the brakes so that the wheels remain within a sliding range generally between 10% and 30%.

In the embodiment shown in FIG. 8 where the brake-assist device may perform an independent braking for each wheel, the vehicle may comprise a rotation speed sensor for each wheel providing processing unit 38 with a signal representative of the wheel rotation speed. Processing unit 38 is capable, based on the information from the speed sensor, of independently controlling each electric motor 42, 144, 154, 164 to decrease the brake-assist force if the associated wheel is about to be locked. In the embodiments shown in FIGS. 5, 6, and 7 where a braking action is performed simultaneously at least on two wheels, an anti-lock function for these wheels may be generally provided on the wheels, even if only one of them tends to lock.

Braking system 30, 130, 140, 150, 160 may further enable to carry out a braking correction function. Indeed, during a braking, a phenomenon of mass transfer from the back to the front of the vehicle occurs. This may cause a locking of the back wheels if the braking action on these wheels is too strong. On a conventional hydraulic braking system such as that shown in FIG. 1, hydraulic corrector 26 is provided to decrease the brake fluid pressure transmitted to the rear brakes. In the embodiments previously described in FIGS. 5 to 8, the hydraulic corrector is not present. For the embodiment previously described in FIG. 5, the difference between the braking intensities of the rear brakes and of the front brakes may be obtained by a mechanism of adaptation to the level of drive mechanism 44 of by different lever structures at the level of rear brakes 16, 18 with respect to front brakes 12, 14. For the embodiments previously described in FIGS. 6 to 8, the difference between the braking intensities of the rear brakes and of the front brakes may be calculated by processing unit 38, which independently controls the electric motor or the electric motors associated with the front wheels and the electric motor or the electric motors associated with the back wheels. Further, the brake-assist difference between the rear brakes and the front brakes may be adapted according to the vehicle load.

Braking system 30, 130, 140, 150, 160 may further enable to carry out an emergency brake-assist function. The vehicle then further comprises a sensor, for example, a speed or acceleration sensor, at the level of brake pedal 27, capable of providing processing unit 38 with a signal representative of the rapidity with which the driver presses on the brake pedal. Processing unit 38 can then detect an emergency situation when the speed at which the driver presses on brake pedal 27 exceeds a threshold. Processing unit 38 can then control the obtaining of a maximum braking effort as rapidly as possible.

As a variation, a booster battery in addition to the main battery of the vehicle may be provided to guarantee the use of the brake-assist device in case of an electric power loss of the vehicle.

Specific embodiments have been described. Various alterations and modifications will occur to those skilled in the art. In particular, although the previously-described embodiments describe the use of a brake pedal, it should be clear that the present embodiments can be implemented with any type of braking actuation member, for example, a manual control at the steering wheel. Further, although the use of rotating electric motors has been described in the previously-described embodiments, it should be clear that the present embodiments can be implemented with electric stepping motors.

1. A braking system (30; 130; 140; 150; 160) for at least one first wheel of a motor vehicle comprising a first brake (18), a hydraulic circuit (20, 24) for controlling the first brake and a first electric motor (42) for controlling the first brake, said circuit and said motor being at least partly simultaneously actuable by a same actuation member (27).

2. The braking system of claim 1, comprising a sensor (34) capable of providing a signal (S) representative of the driver's action on the actuation member (27), a processing unit (38) capable of providing a set point value (C) from said signal, the first electric motor (42) being controlled based on said set point value.

3. The braking system of claim 1, wherein the first brake (18) is hydraulically controlled and mechanically controlled, the hydraulic circuit (20, 24) being connected to the hydraulic control system of the first brake and the first electric motor (42) being connected to the mechanical control system of the first brake

4. The braking system of claim 3, wherein the hydraulic circuit comprises a master cylinder (20) connected to the hydraulic control system of the first brake (18) by at least one pipe (24) containing a brake fluid, the braking system comprising a connection mechanism (29) mechanically connecting the actuation member (27) to at least one piston of the master cylinder, the connection mechanism comprising no servo-brake.

5. The braking system of any of claims 1 to 4, comprising a second hydraulically controlled and mechanically controlled brake (14), the hydraulic circuit (20, 22) being connected to the hydraulic control system of the second brake.

6. The braking system of claim 5, wherein the first motor (42) is further connected to the mechanical control system of the second brake (14).

7. The braking system of claim 5, further comprising a second electric motor (144) connected to the mechanical control system of the second brake (14) and controlled by the actuation member (27) at least partly simultaneously with the hydraulic circuit (20, 22).

8. The braking system of any of claims 5 to 7, comprising a third hydraulically controlled and mechanically controlled brake (16), the hydraulic circuit (20, 23) being connected to the hydraulic control system of the third brake.

9. The braking system of claim 8, wherein the first motor (42) is further connected to the hydraulic control system of the third brake (16).

10. The braking system of claim 8, further comprising a third electric motor (154) connected to the mechanical control system of the third brake (16) and controlled by the actuation member (27) at least partly simultaneously with the hydraulic circuit (20, 23).

11. The braking system of any of claims 8 to 10, comprising a fourth hydraulically controlled and mechanically controlled brake (12), the hydraulic circuit (20, 21) being connected to the hydraulic control system of the fourth brake.

12. The braking system of claim 11, wherein the first motor is further connected to the hydraulic control system of the fourth brake (12).

13. The braking system of claim 11, further comprising a fourth electric motor (164) connected to the mechanical control system of the fourth brake (12) and controlled by the actuation member (27) at least partly simultaneously with the hydraulic circuit (20, 21).

14. A vehicle comprising at least one wheel and a system for braking said wheel of any of claims 1 to 13.
